(19) United States
(12) Patent Application Publication
(10) Pub. No.: US 2024/0365273 A1
(43) Pub. Date: Oct. 31, 2024

(54) JOINT CELLULAR AND WIRELESS LOCAL AREA NETWORK (WLAN) POSITIONING

(71) Applicant: QUALCOMM Incorporated, San Diego, CA (US)

(72) Inventors: Anantharaman BALASUBRAMANIAN, San Diego, CA (US); Shuanshuan WU, San Diego, CA (US); Hong CHENG, Basking Ridge, NJ (US); Mohit NARULA, San Diego, CA (US)

(21) Appl. No.: 18/307,987

(22) Filed: Apr. 27, 2023

(51) Int. Cl. H04W 64/00

(52) U.S. Cl. CPC H04W 64/00

(57) ABSTRACT

In some implementations, a server may receive, from the target UE, a message indicative of: a capability of the target UE for WLAN positioning, and an absence of a sidelink interface of the target UE with another UE. The server may send instructions to one or more prospective assistance UEs to initiate WLAN functionality to enable the target UE to associate with the one or more prospective assistance UEs. The server may receive, from the one or more prospective assistance UEs, WLAN identification information of the one or more prospective assistance UEs. The server may send WLAN identification information of the one or more prospective assistance UEs to the target UE.

### BACKGROUND

### 1. Field of Disclosure

The present disclosure relates generally to the field of radiofrequency (RF)-based position determination (or positioning) of an electronic wireless device. More specifically, the present disclosure relates to positioning using cellular and wireless local area network (WLAN) wireless technologies.

### 2. Description of Related Art

The positioning of devices can have a wide range of consumer, industrial, commercial, military, and other applications. The position of a device can be estimated based on information gathered using different RF positioning technologies. Cellular networks (e.g., fifth-generation (5G) new radio (NR) networks) may be capable of positioning a user equipment (UE) using cellular signals from between the UE and one or more base stations of the cellular network. Positioning a UE may additionally use cellular signals between the UE and one or more other UEs.

### BRIEF SUMMARY

An example method of supporting wireless local area network (WLAN) positioning of a target user equipment (UE) by a server of a cellular network, according to this disclosure, may comprise receiving, at the server from the target UE, a message indicative of a capability of the target UE for WLAN positioning, and an absence of a sidelink interface of the target UE with another UE. The method also may comprise sending instructions from the server to one or more prospective assistance UEs to initiate WLAN functionality to enable the target UE to associate with the one or more prospective assistance UEs. The method also may comprise receiving, at the server from the one or more prospective assistance UEs, WLAN identification information of the one or more prospective assistance UEs. The method also may comprise sending the WLAN identification information of the one or more prospective assistance UEs from the server to the target UE.

An example method of supporting wireless local area network (WLAN) positioning of a target user equipment (UE) of a cellular network, according to this disclosure, may comprise sending, from the target UE to a server, a message indicative of a capability of the target UE for WLAN positioning, and an absence of a sidelink interface of the target UE with another UE. The method also may comprise receiving, at the target UE from a server, WLAN identification information regarding one or more prospective assistance UEs. The method also may comprise establishing a WLAN association of between the target UE and at least a subset of the one or more prospective assistance UEs based at least in part on the WLAN identification information. The method also may comprise performing, with the target UE, WLAN positioning with the at least a subset of the one or more prospective assistance UEs.

An example server for supporting wireless local area network (WLAN) positioning of a target user equipment (UE) by a server of a cellular network, according to this disclosure, may comprise a transceiver, one or more memories, one or more processors communicatively coupled with the transceiver and the one or more memories, wherein the one or more processors are configured to receive, via the transceiver from the target UE, a message indicative of: a capability of the target UE for WLAN positioning, and an absence of a sidelink interface of the target UE with another UE. The one or more processors further may be configured to send instructions via the transceiver to one or more prospective assistance UEs to initiate WLAN functionality to enable the target UE to associate with the one or more prospective assistance UEs. The one or more processors further may be configured to receive, via the transceiver from the one or more prospective assistance UEs, WLAN identification information of the one or more prospective assistance UEs. The one or more processors further may be configured to send the WLAN identification information of the one or more prospective assistance UEs via the transceiver to the target UE.

An example target UE for supporting wireless local area network (WLAN) positioning of a target user equipment (UE) of a cellular network, according to this disclosure, may comprise a transceiver, one or more memories, one or more processors communicatively coupled with the transceiver and the one or more memories, wherein the one or more processors are configured to send, via the transceiver to a server, a message indicative of: a capability of the target UE for WLAN positioning, and an absence of a sidelink interface of the target UE with another UE. The one or more processors further may be configured to receive, via the transceiver from a server, WLAN identification information regarding one or more prospective assistance UEs. The one or more processors further may be configured to establish a WLAN association of between the target UE and at least a subset of the one or more prospective assistance UEs based at least in part on the WLAN identification information. The one or more processors further may be configured to perform WLAN positioning with the at least a subset of the one or more prospective assistance UEs.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified illustration of a positioning system, according to an embodiment.

FIG. 2 is a fifth-generation (5G) new radio (NR) positioning system, which illustrates how some aspects of the positioning system of FIG. 1 may be implemented in a wireless network, according to an embodiment.

FIGS. 3A-3B are diagrams illustrating how positioning may be performed using wireless technologies such as cellular (e.g., 5G NR) and wireless local area network (WLAN) technologies, according to an embodiment.

FIG. 4 is a diagram of an example scenario in which joint cellular and WLAN positioning of a target user equipment (UE) may be performed, according to an embodiment.

FIG. 5 is a message flow diagram of a process for performing joint cellular/WLAN positioning of UE, according to an embodiment.

FIG. 6 is a flow diagram of a method of supporting WLAN positioning of a target UE by a server of a cellular network, according to an embodiment.

FIG. 7 is a flow diagram of a method of supporting WLAN positioning of a target UE of a cellular network, according to an embodiment.

FIG. 8 is a block diagram of an embodiment of a UE.

FIG. 9 is a block diagram of an embodiment of a computer system.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE) in a 5G new radio (NR) network. As described in more detail herein, such signals may comprise any of a variety of signal types but may not necessarily be limited to a Positioning Reference Signal (PRS) as defined in relevant wireless standards.

Further, unless otherwise specified, the term “positioning” as used herein may include absolute location determination, relative location determination, ranging, or a combination thereof. Such positioning may include and/or be based on timing, angular, phase, or power measurements, or a combination thereof (which may include RF sensing measurements) for the purpose of location or sensing services.

Further, unless otherwise specified, the term “positioning” as used herein (including, for example, WLAN-based positioning, cellular-based positioning, and hybrid/joint positioning) may involve absolute location determination, relative location termination, ranging, or a combination thereof. Such positioning may include and/or be based on timing, angular, phase, or power measurements, or a combination thereof (which may include RF sensing measurements) for the purpose of location or sensing services.

As noted, device positioning of a user equipment (UE) may use cellular signals from between the UE and one or more base stations of the cellular network. A cellular interface between a UE and a base station may be referred to as a Uu interface. Positioning a UE may additionally or alternatively use cellular signals between the UE and one or more other UEs. A cellular interface between two UEs may be referred to as a sidelink (sometimes abbreviated as “SL”) interface. Enhancements to 5G cellular architecture will enable sidelink positioning in in-coverage, partial-coverage, and out-of-network-coverage scenarios. To this end, several proposals have been put forth for joint Uu and sidelink positioning in relevant technical specifications to cover ranging/SL positioning device discovery, ranging and positioning exposure service to application layer, network-assisted sidelink positioning in network coverage and partial coverage, control of operations for ranging/SL positioning, in the like. Proposals have not, however, addressed the control operations for joint positioning of a UE with another UE (also referred to herein as an “anchor” UE), but without the use and/or presence of a sidelink interface, but with the presence of an alternative interface, such as WLAN (e.g., 802.11/Wi-Fi).

Various aspects relate generally to utilizing a cellular network to coordinate WLAN positioning of a target UE using one or more assistance UEs. Some aspects more specifically relate to signaling between the target UE, one or more cellular network nodes (e.g., a server), and one or more assistance UEs. In some examples, the target UE may inform the network of an ability to perform WLAN positioning and an inability for unavailability to perform sidelink positioning. The network may then prepare nearby UEs who act as assistance UEs for WLAN positioning by sharing WLAN information of the target UE (e.g., SSID information, MAC address, etc.) with the nearby UEs. The target UE and nearby UEs may then associate with one another and perform WLAN positioning via WLAN connections. According to some embodiments, WLAN positioning outcomes may be provided to the one or more cellular network nodes.

Particular aspects of the subject matter described in this disclosure can be implemented to realize one or more of the following potential advantages. In some examples, by coordinating WLAN positioning, the described techniques can be used to provide positioning of a target UE in cases where sidelink positioning may be unavailable, but where WLAN positioning can be used in a similar manner (e.g., to determine a standalone position of the target UE and/or complement other positioning techniques). This can leverage available WLAN connections to provide positioning of a target UE in cases where positioning of the target UE may be otherwise unavailable or less reliable. These and other advantages will be more apparent to a person of ordinary skill in the art in view of the embodiments provided herein. Embodiments are detailed below after a review of related technologies.

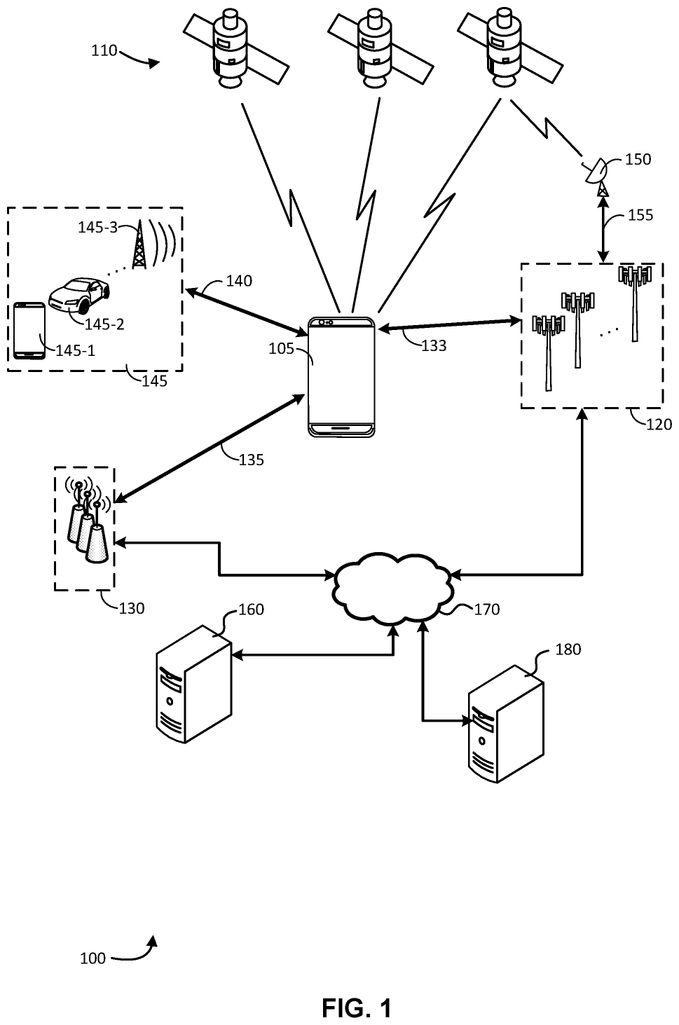

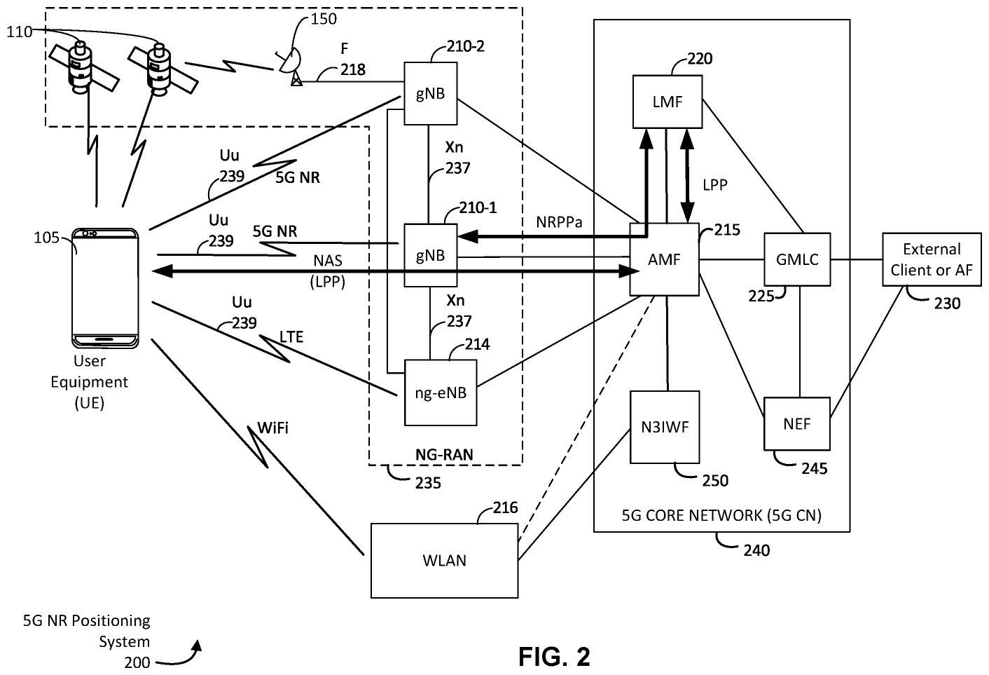

FIG. 1 is a simplified illustration of a positioning system 100 in which a UE 105, location server 160, and/or other components of the positioning system 100 can use the techniques provided herein for determining an estimated location of UE 105 using joint cellular and WLAN positioning, according to an embodiment. The techniques described herein may be implemented by one or more components of the positioning system 100, however the techniques described herein are not limited to such components and may be implemented in other types of systems (not shown). The positioning system 100 can include: a UE 105; one or more satellites 110 (also referred to as space vehicles (SVs)) for a Global Navigation Satellite System (GNSS) (such as the Global Positioning System (GPS), GLONASS, Galileo or Beidou) and/or NTN functionality; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As noted, satellites 110 may be used to implement NTN functionality, extending communication, positioning, and potentially other functionality (e.g., RF sensing) of a terrestrial network. As such, one or more satellites may be communicatively linked to one or more NTN gateways 150 (also known as “gateways,” “earth stations,” or “ground stations”). The NTN gateways 150 may be communicatively linked with base stations 120 via link 155. In some embodiments, NTN gateways 150 may function as DUs of a base station 120, as described previously. Not only can this enable the UE 105 to communicate with the network 170 via satellites 110, but this can also enable network-based positioning, RF sensing, etc.

As used herein, the term “cell” may generically refer to a logical communication entity used for communication with a base station 120 and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the UE 105, or a combination thereof. Wireless signals from mobile devices 145 used for positioning of the UE 105 may comprise RF signals using, for example, Bluetooth® (including Bluetooth Low Energy (BLE)), IEEE 802.11x (e.g., Wi-Fi®), Ultra-Wideband (UWB), IEEE 802.15x, or a combination thereof. Mobile devices 145 may additionally or alternatively use non-RF wireless signals for positioning of the UE 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular UE 105, the UE 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and UE 105 may comprise sidelink and/or similar Device-to-Device (D2D) communication technologies. Sidelink, which is defined by 3GPP, is a form of D2D communication under the cellular-based LTE and NR standards.

According to some embodiments, such as when the UE 105 comprises and/or is incorporated into a vehicle, a form of D2D communication used by the UE 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The UE 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the UE 105 and may be used to determine the position of the UE 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the UE 105, according to some embodiments.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations 120 of FIG. 1, and the WLAN 216 may correspond with one or more access points 130 of FIG. 1. Optionally, the 5G NR positioning system 200 additionally may be configured to determine the location of a UE 105 by using an LMF 220 (which may correspond with location server 160) to implement the one or more positioning methods. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. Additional components of the 5G NR positioning system 200 are described below. The 5G NR positioning system 200 may include additional or alternative components.

The 5G NR positioning system 200 may further utilize information from satellites 110. As previously indicated, satellites 110 may comprise GNSS satellites from a GNSS system like Global Positioning System (GPS) or similar system (e.g. GLONASS, Galileo, Beidou, Indian Regional Navigational Satellite System (IRNSS)). Additionally or alternatively, satellites 110 may comprise NTN satellites. NTN satellites may be in low earth orbit (LEO), medium earth orbit (MEO), geostationary earth orbit (GEO) or some other type of orbit. NTN satellites may be communicatively coupled with the LMF 220 and may operatively function as a TRP (or TP) in the NG-RAN 235. As such, satellites 110 may be in communication with one or more gNBs 210 via one or more NTN gateways 150. According to some embodiments, an NTN gateway 150 may operate as a DU of a gNB 210, in which case communications between NTN gateway 150 and CU of the gNB 210 may occur over an F interface 218 between DU and CU.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of satellites 110, gNBs 210, ng-eNBs 214, Wireless Local Area Networks (WLANs) 216, Access and mobility Management Functions (AMF)s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High-Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 105. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. As noted, this can include gNBs 210, ng-eNB 214, WLAN 216, and/or other types of cellular base stations, and may also include NTN satellites 110. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214, WLAN 216, or NTN satellite 110.

In some embodiments, an access node, such as a gNB 210, ng-eNB 214, WLAN 216, or NTN satellite 110, or a combination thereof, (alone or in combination with other components of the 5G NR positioning system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes (gNB 210, ng-eNB 214, WLAN 216, and NTN satellite 110) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node (e.g., gNB 210, ng-eNB 214, WLAN 216, or NTN satellite 110) of a first RAT to an access node of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such gNB 210, ng-eNB 214, WLAN 216, or NTN satellite 110, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable the secure provision of information from the external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE-based position methods such as A-GNSS, RTK, TDOA, multi-cell RTT, AoD, and/or ECID. The NRPPa protocol may be used to support positioning of UE 105 using network-based position methods such as ECID, AoA, uplink TDOA (UL-TDOA) and/or may be used by LMF 220 to obtain location-related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), RSTD, Time of Arrival (TOA), AoA, Receive Time-Transmission Time Difference (Rx-Tx), Differential AoA (DAoA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for GNSS satellites), WLAN, etc.

With a UE-based position method, UE 105 may obtain location measurements (e.g., which may be the same as or similar to location measurements for a UE-assisted position method) and may further compute a location of UE 105 (e.g., with the help of assistance data received from a location server such as LMF 220, an SLP, or broadcast by gNBs 210, ng-eNB 214, or WLAN 216).

With a network-based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, which is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

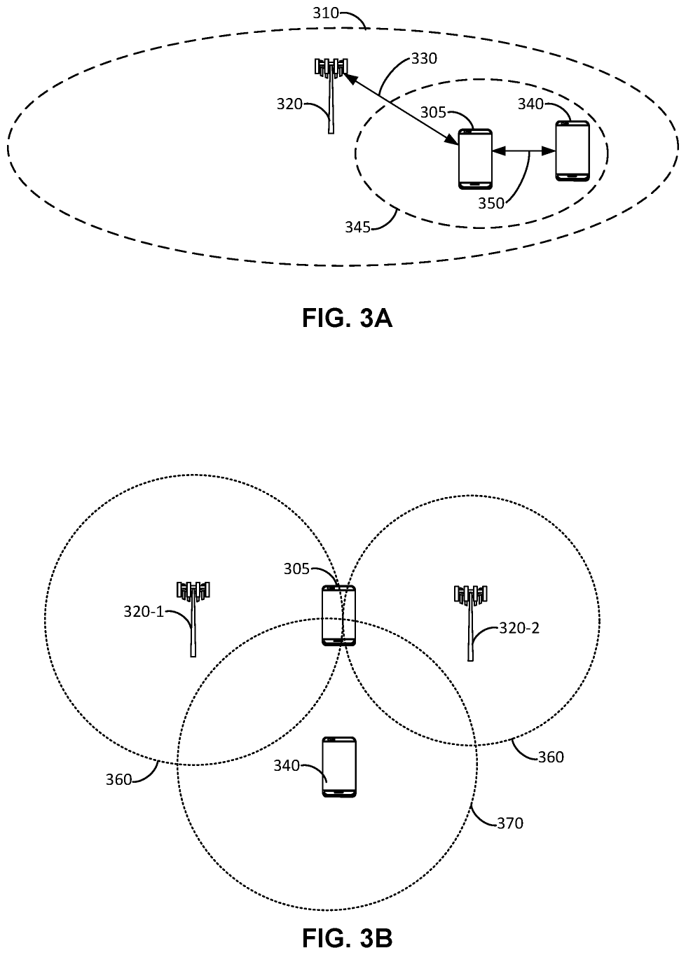

According to embodiments herein, the positioning of a UE can leverage both a cellular connection between the UE and a base station (e.g., a Uu interface) and a WLAN interface (also referred to herein as a Wi-Fi interface or 802.11 interface) with another UE. FIGS. 3A-3B generally illustrate how such positioning may be performed.

FIG. 3A is a diagram illustrating a scenario in which both D2D (e.g., direct wireless between devices) and cellular (5G NR) technologies may be used for joint positioning of a target device 305. Here, target device 305 may correspond with UE device 105 of FIGS. 1 and/or 2. Generally put, according to some embodiments, the joint positioning of a device may utilize both cellular and D2D (e.g., sidelink, WLAN (Wi-Fi/802.11), UWB) positioning technologies to determine the location of a device that is capable of taking positioning-related measurements in both cellular and D2D technologies. The use of both cellular and D2D technologies may utilize additional anchors (cellular and/or D2D anchors) for positioning measurements, which can allow for positioning of a device in situations where the use of a single technology would not, and/or increased accuracy over the use of a single technology.

In this scenario, a target device 305 may comprise a UE of the cellular network within a coverage region 310 of a base station 320, which may comprise a serving base station of the target device 305. Communication between the base station 320 and target device 305 may occur across a network (Uu) interface 330, which may also be used to communicate DL and/or UL reference signals for cellular aspects of joint positioning. According to some embodiments, the positioning of the target device 305 may be coordinated by the network via a location server (not shown), and related configuration data and/or assistance data may be related to the target device 305 by the base station 320 via the network interface 330.

With respect to the D2D aspects of joint positioning, the target device 305 may send and/or receive D2D RF signals via a direct wireless interface 350 (with a range shown by circle 345) from D2D device 340, acting as a D2D anchor. According to some embodiments, the D2D aspects of joint positioning may be coordinated by the target device 305 and/or D2D device 340, or maybe coordinated by location or other server (not shown). In some embodiments, configuration data and/or assistance data may be provided to a target device 305 and/or D2D device 340 directly by the base station 320. In some embodiments, configuration data and/or assistance data may be provided to a target device 305 directly by the base station 320 (e.g., via the network interface 330), and the target device 305 may relay the configuration data and/or assistance data to the D2D device 340. As referred to herein, an “assistance” UE may comprise a UE that provides assistance data to a target UE. In some configurations, and assistance UE main also function as an anchor UE.

It can be noted that, although a single base station 320 and a single D2D device 340 are illustrated in FIG. 3A, scenarios in which joint positioning of a target device 305 may include one or more base stations and one or more D2D devices.

FIG. 3B is a simplified diagram illustrating how positioning of the target device 305 may be performed, according to some embodiments. Here, measurements using cellular technology may comprise round trip signal propagation delay (RTT) measurements or similar ranging measurements performed between the target device 305 and each of a first base station 320-1 and a second the base station 320-2 to determine a distance between the target device 305 and the base stations 320. (These distances are represented by circles 360.) Additionally, as indicated, measurements and D2D may comprise RTT measurements (also referred to as two-way ranging (TWR)) performed to determine a distance between the target device 305 and one or more D2D anchors, such as D2D device 340. (The distance between the target device 305 and the D2D device 340 is represented by circles 370.) Using multilateration, the location of the target device 305 may be determined as the location in which circles representing the distances (circles 360 and 370) intersect. Because the distances may have some uncertainty, the resulting location of the target device 305 also may have some uncertainty.

In practice, the positioning of the target UE in the manner illustrated in FIGS. 3A and 3B using a single D2D technology, such as sidelink, may experience some issues. For example, due to non-line-of-sight (NLOS) conditions experienced by the target UE on a network base station, the network may be unable to position the target UE effectively (e.g., due to high variance in the positioning error). If the network may then attempt to use an anchor UE to determine the position of the target UE. However, a sidelink interface between the anchor UE and target UE may not be established. This may be the case, for example, when sidelink has yet to be established in the relevant wireless standards, or when one or both of the UEs is operating on an older version of wireless cellular standards in which sidelink has not been deployed. Further, although both anchor and target UEs may have a separate WLAN interface with which ranging/positioning made be performed, traditional positioning may not be capable of utilizing the WLAN interface because this use case has not yet been treated in relevant technical specifications.

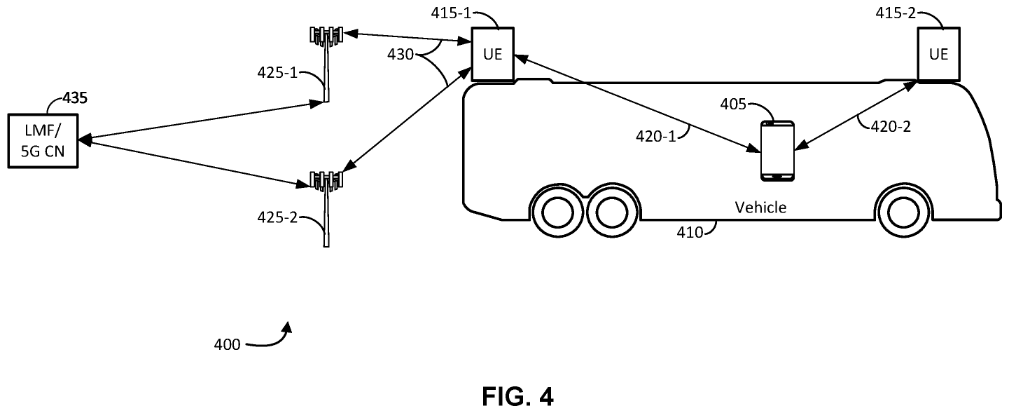

FIG. 4 is a diagram of an example scenario 400 in which the joint positioning of the target UE 405 may be performed, according to some embodiments. In this scenario 400, the target UE 405 is located on a vehicle 410 (e.g., a transit vehicle such as a bus, train, etc.) having a first assistance UE 415-1 and a second assistance UE 415-2 (collectively and generically referred to herein as assistance UEs 415), which can represent TRPs of the vehicle 410. The target UE 405 further has WLAN connections 420-1 and 420-2 (collectively and generically referred to herein as WLAN connections 420) with the first assistance UE 415-1 and the second assistance UE 415-2, respectively. The first assistance UE 415-1 is communicatively coupled with a first base station 425-1 and a second base station 425-2 with Uu interfaces 430. The base stations 425 are communicatively coupled with the LMF 435 located in the 5G core network. The target UE 405 and the second assistance UE 415-2 optionally may have established Uu links with either or both of the base stations 425 (although not necessary), and the assistance UEs 415 may be communicatively coupled via wireless and/or wired means. As with other figures, FIG. 4 is provided as a nonlimiting example. Embodiments herein may be applied to various other scenarios, which may be far different from the scenario 400 of FIG. 4.

Given the state of current cellular and WLAN technologies, the scenario 400 and scenarios like it may be common. That is, assistance UEs 415 may have WLAN connections 420 (e.g., 802.11) with the target UE 405, but may not have a sidelink connection with the target UE 405. In scenario 400, traditional techniques do not address methods and signaling procedures for using assistance UEs 415 to position the target UE 405 using the WLAN connections 420, alerting the base stations 425 of the existence of the WLAN connections 420, discovering which assistance UE 415 may act as a WLAN station (STA) and which assistance UE 415 may act as a WLAN access point (AP), performing network-based and/or UE-assisted WLAN discovery for positioning the target UE 405, or providing signaling with the LMF 435 accomplish any of these functions.

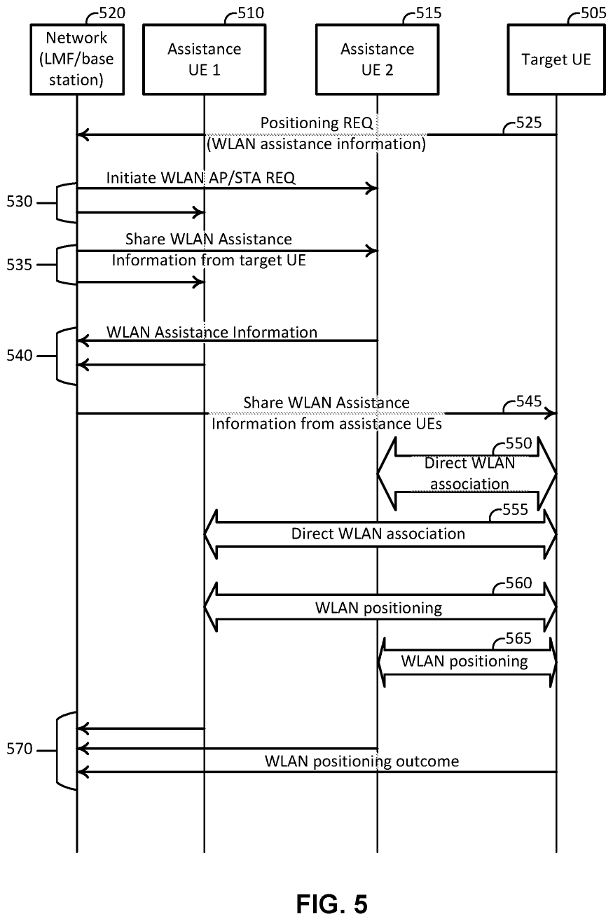

Embodiments herein address these and other issues by establishing procedures in which the positioning of a target UE by a cellular network can utilize WLAN connections of the target UE to perform joint cellular/WLAN positioning of the target UE. An example flow diagram of such procedures is illustrated in FIG. 5.

FIG. 5 is a message flow diagram of a process for performing joint cellular/WLAN positioning of a UE, according to an embodiment. In this example, the entities between which messages are exchanged correspond with entities of the scenario 400 of FIG. 4, namely a target UE 505, a first assistance UE 510, a second assistance UE 515, and the network 520 (which may specifically comprise the LMF and/or base station). That said, embodiments are not so limited. The process of FIG. 5 may be performed with any number of assistance UEs, for example, including only one assistance UE or more than two assistance UEs. Similar to the scenario 400 of FIG. 4, the process of FIG. 5 may be performed in cases in which the target UE 505 does not have a sidelink connection with assistance UEs 510 and 515, but has (or can establish) WLAN (e.g., Wi-Fi/802.11) connections with each. Communication from the target UE 505 to the network 520 may be made via a Uu link between the target UE 505 and a base station of the network 520, or may be made via a WLAN link between the target UE 505 and either assistance UE 510 and 515 (which may have a Uu link with a base station of the network 520). As previously noted, communications between a UE (e.g. target UE 505 and/or assistance UEs 510 and 515) and an LMF (e.g., network 520) may be performed via LPP. Further, positioning-related signaling between a UE and a base station may be coordinated by an LMF.

The process may begin with the functionality shown by arrow 525, in which the target UE 505 sends a positioning request (REQ) to the network 520. The UE 505 may send the positioning request in response to a triggering event, such as an app-layer request for the position of the target UE 505 (e.g., a navigation app, browser-based location request, a user request for location via an app, etc.). As indicated in FIG. 5, the positioning request can include WLAN assistance information, and may further indicate an inability to perform sidelink communication/positioning. The WLAN assistance and information may generally include information enabling the network 520 to coordinate WLAN positioning. More specifically, the assistance information may include, for example, information indicative of (i) a capability of the target UE 505 regarding whether it can act as an STA (client) or as an AP (access point), (ii) a WLAN-AP identifier (e.g., SSID) of the target UE 505 if it can act as an AP, (iii) one or more WLAN-AP identifiers that the target UE 505 can sense in its environment (e.g., SSIDs of assistance UEs 510 and 515), (iv) MAC addresses for one or more assistance UEs that it is able to sense, (v) signal strength information (e.g., RSRP) of each the of the WLAN-AP identifiers (e.g., SSIDs) of other UEs the target UE 505 can sense, (vi) a capability of the target UE 505 regarding whether it can perform direct WLAN association/communication (e.g., Wi-Fi-direct) with other WLAN devices (e.g., assistance UEs 510 and 515), or (vii) any combination thereof (e.g., any combination of items (i)-(vi)). In instances in which the target UE 505 can support direct WLAN communication, the target UE 505 may further indicate his capability with regard to whether can act as a P2P GO (group owner) or a P2P client. Additionally or alternatively, if the target UE 505 already has an active/inactive WLAN connection or is already performing direct WLAN communication (e.g., Wi-Fi direct) with an assistance UE 510 and/or 515, the target UE 505 may further provide current status regarding the connection such as whether the connection is (i) not authenticated or associated, (ii) authenticated but not associated, or (iii) authenticated & associated. This assistance data may be provided by the target UE 505 (e.g., optionally with the positioning request, as indicated in FIG. 5) if the target UE 505 determines sidelink is not available, but WLAN assistance may be (e.g., as determined by sensing SS IDs of neighboring UEs/WLAN devices).

According to some embodiments, upon receiving the assistance information from the target UE 505, the network can then choose an appropriate WLAN device that can provide a QOS requirement for positioning the target UE 505 (which may be known/determined by the target UE 505 and, in some embodiments, included in the positioning request). For example, if the positioning requirement of the target UE 505 has a required latency, then the network by 20 (e.g., LMF or base station) may choose an assistance UE 510 and/or 515 (e.g., operating as an AP) that is already authenticated and associated rather than looking for a very high signal strength AP with the target UE 505. On the other hand, if the positioning requirement is with respect to accuracy (e.g., a minimum accuracy threshold), then the network 520 may choose an assistance UE 510 and/or 515 that is not authenticated and associated or authenticated and not associated, with high signal strength with the target UE 505.

According to some embodiments, the assistance information detailed above may be sent to the network 520 (specifically, the LMF) in one or more of the following ways. According to a first option, the target UE 505 may send the WLAN assistance data using non-access stratum (NAS) signaling to the network, which forwards the information to the LMF using the next-generation control plane interface (NG-C) and NL interface (between AMF and LMF). According to a second option, the target UE 505 can send assistance information regarding a possible assistance UE 510 and/or 515 using LPP, as previously noted.

Table 1 shows an example information element (IE) that could be used in an LPP message from a target UE to an LMF to convey such WLAN assistance data. As a person of ordinary skill in the art will appreciate, this may be modified to accommodate any number of potential assistance UEs.

TABLE 1
LPP WLAN Assistance Data IE

WLAN-ProvideAssistanceData-r14 ::= SEQUENCE {
wlan-DataSet-r14 SEQUENCE (SIZE (1..maxWLAN-DataSets-r14)) OF
WLAN-DataSet-r14
OPTIONAL, -- Need ON
assistance UE-1 -- {all WLAN assistance information related to UE-1 }
assistance UE-2 --{all WLAN assistance information related to UE-2 }
}

Returning to FIG. 5, once the network 520 receives the positioning request with WLAN assistance information, it may then initiate WLAN AP/STA requests, as indicated by arrows 530, which can enable the assistance UEs 510 and 515 to be discoverable by the target UE 505 and/or may prepare the assistance UEs 510 and 515 for associating with the target UE 505 and performing WLAN positioning of the target UE 505. As shown by arrows 535, the network may then share WLAN assistance information received by the target UE with the assistance UEs 510 and 515, which can be used by the assistance UEs 510 and 515 to later associated with the target UE 505 to perform WLAN positioning. As shown by arrows 540, the assistance UEs 510 and 515 can provide their own WLAN assistance information to the network 520, which may include capability information, ID information, and/or other information to allow the network 520 to coordinate WLAN positioning with the target UE 505. At arrow 545, the network 520 shares the WLAN assistance information received from the assistance UEs 510 and 515 with the target UE 505, which can allow the target UE 505 to associate with the assistance UEs 510 and 515. The association and positioning are then performed by arrows 550-565, in which the target UE 505 and assistance UEs 510 and 515 establish a direct WLAN association (arrows 550 and 555) and then perform WLAN positioning arrows 560 and 565. At arrows 570, the target UE 505 and the assistance UEs 510 and 515 and report WLAN positioning outcomes (e.g., measurements) to the network 520, which may then calculate the position of the target UE 505 from these outcomes. In some embodiments, the network 520 may further provide the calculated position to the target UE 505 (not shown). Additionally or alternatively to providing WLAN positioning outcomes to the network 520 shown by arrows 570, assistance UEs 510 and 515 may provide the target UE 505 with WLAN positioning outcomes, in which case the target UE 505 may calculate its position using these outcomes and any further measurements/outcomes obtained by the target UE 505 during positioning.

Alternative embodiments may utilize a different process for coordinating WLAN positioning, or may implement variations on the process illustrated in FIG. 5. For example, according to some embodiments, the target UE 505 may not provide WLAN assistance information at arrow 525, but may instead indicate the absence of a sidelink interface and the presence of a WLAN interface, along with a MAC address and/or STA ID. In such embodiments, the network 520 may initiate discovery of assistance UEs 510 and 515 as follows. First, the base station may use rough location information regarding the target UE 505 (e.g., obtained using Uu interface) to identify possible assistance UEs near the target UE 505 (e.g., within a threshold distance) that are capable of providing WLAN positioning (e.g., which may involve acting as an access point). After doing so, the base station may either (i) indicate to the possible assistance UEs (e.g., assistance UEs 510 and 515) to initiate AP functionality, request identifier information (e.g., MAC address, SSID, etc.) or supported WLAN interfaces, and (optionally) provide identifier information (e.g., MAC address) of the target UE 505 the possible assistance UEs; or (ii) instruct the possible assistance UEs to enable Wi-Fi Direct, and act as P2P GO/P2P client. After performing either (i) or (ii), the base station may then provide identifier information of the possible assistance UEs to the target UE 505 to enable the target UE 505 to sense and possibly authenticate/associate with one or more of the possible assistance UEs via the WLAN interface. Embodiments may then employ one or more of the following options: in a first option, the target UE 505 may then inform the network 520 (e.g., base station) of the status of whether it is able to associate it to the SSID of the one or more assistance UEs; in a second option, the one or more assistance UEs inform the network of the status of whether it can receive a “Probe Request” from the target UE; and in ⅓ option the target UE and one or more assistance UEs are able to discover each other using Wi-Fi Direct, and either or both, indicate their discovery status to the network 520.

According to some embodiments, one or more assistance UEs may provide assistance information to the network. Is a variation to the process shown in FIG. 5, for example, WLAN assistance information may be provided by the assistance UEs 510 and/or 515 to the network 520 (e.g., a base station), which can relay this information to the target UE 505 to enable the target UE 505 and the assistance UEs 510 and/or 515 to discover each other for purposes of WLAN positioning. UEs are capable and/or willing to serve as assistance UEs for WLAN positioning may provide assistance information comprising one or more of a MAC address, SSID it supports, Wi-Fi Direct capability to act as P2P GO/P2P client, or the like. According to some embodiments, the assistance information provided by potential assistance UEs to the network may be provided to a target UE in response to a request (e.g., a positioning request for the positioning data of nearby UEs) from the target UE. Once assistance information has been provided to the target UE, the target UE and one or more assistance UEs may perform WLAN positioning and provide WLAN positioning outcomes to the LMF via NAS signaling or via LPP, as previously described with respect to FIG. 5.

It can be noted that embodiments may involve the network mapping WLAN identification information (e.g., MAC address, society, etc.) of various UEs with cellular/UE identification information (e.g., 3GPP ID). This can enable functionality in certain embodiments where the network can identify and communicate with a UE corresponding to an SSID detected by another UE. This information can be provided by UEs to the network at different times, such as during a positioning procedure (e.g., as part of the positioning request, as indicated in FIG. 5), in response to a request or other message from the network, upon registering with the network, or any combination thereof.

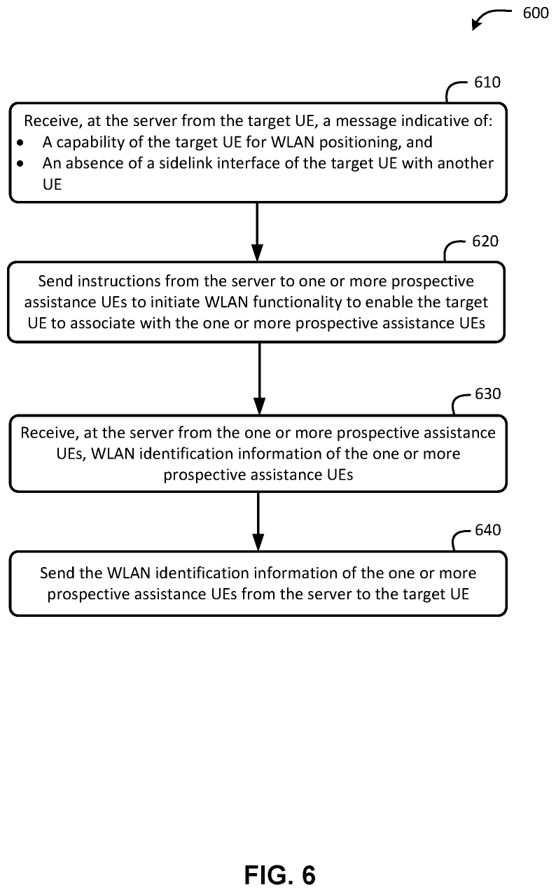

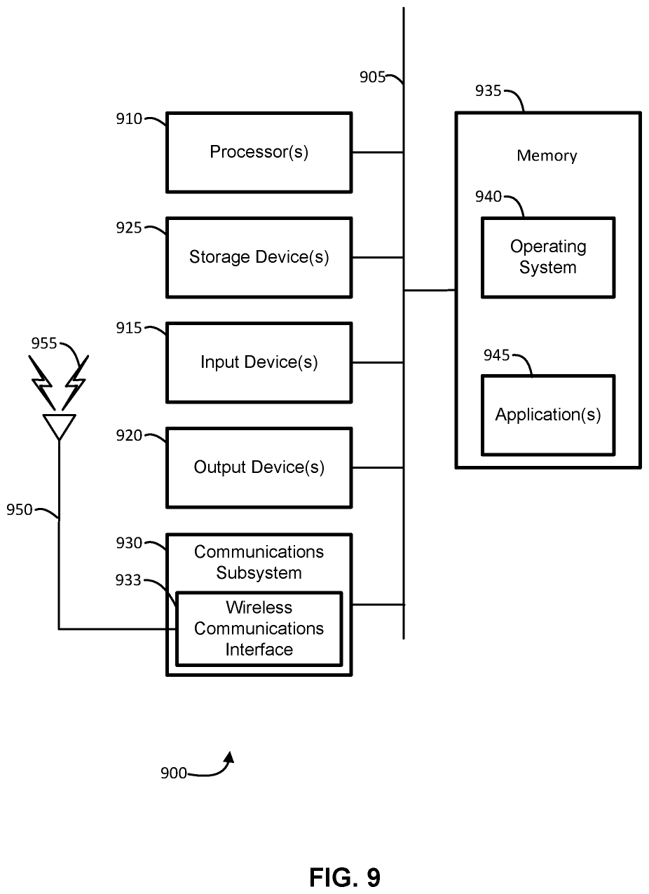

FIG. 6 is a flow diagram of a method 600 of supporting WLAN positioning of a target UE by a server of a cellular network, according to an embodiment. Means for performing the functionality illustrated in one or more of the blocks shown in FIG. 6 may be performed by hardware and/or software components of a server, which may be implemented with a computer system. Example components of a computer system are illustrated in FIG. 9, which is described in more detail below.

At block 610, the functionality comprises receiving, at the server from the target UE, a message indicative of: a capability of the target UE for WLAN positioning, and an absence of a sidelink interface of the target UE with another UE. The message at block 710 may correspond with arrow 525 in FIG. 5, as described previously. As noted elsewhere herein, according to some embodiments, the server may comprise an LMF, and the message may be received via LPP or NAS signaling. According to some embodiments, the message may comprise a positioning request, and the positioning request may further include assistance information comprising an indication of: an inability of the target UE to perform sidelink positioning, whether the target UE can act as a WLAN client or WLAN access point, a WLAN-AP identifier of at least one of the one or more prospective assistance UEs detected by the target UE, a MAC addresses of at least one of the one or more prospective assistance UEs detected by the target UE, a signal strength of at least one of the one or more prospective assistance UEs detected by the target UE, whether the target UE can perform in Wi-Fi Direct mode, whether the target UE can act as a peer-to-peer (P2P) group owner (GO) or a P2P client, or any combination thereof. In such embodiments, the assistance information may further comprise an indication that the target UE has a WLAN connection with at least one of the one or more prospective assistance UEs. In some embodiments, the assistance information a further comprise an indication that the WLAN connection is not authenticated and not associated, authenticated and not associated, or authenticated and associated.

Means for performing functionality at block 610 may comprise a bus 905, one or more processors 910, communications subsystem 930, memory 935, and/or other components of a computer system 900, as illustrated as illustrated in FIG. 9, described in more detail hereafter

At block 620, the functionality comprises sending instructions from the server to one or more prospective assistance UEs to initiate WLAN functionality to enable the target UE to associate with the one or more prospective assistance UEs. This functionality may correspond with arrows 530 and/or 535 in FIG. 5, in which WLAN functionality comprises one or more WLAN functions or operations to initiate and/or enable WLAN association and/or positioning operations between the target UE and the one or more prospective assistance UEs. According to some embodiments, the instructions to initiate WLAN functionality may comprise instructions to: operate as a WLAN access point (AP), enable Wi-Fi direct mode, act as a peer-to-peer (P2P) group owner (GO) or a P2P client, or any combination thereof.

Means for performing functionality at block 620 may comprise a bus 905, one or more processors 910, communications subsystem 930, memory 935, and/or other components of a computer system 900, as illustrated in FIG. 9, described in more detail hereafter.

At block 630, the functionality comprises receiving, at the server from the one or more prospective assistance UEs, WLAN identification information of the one or more prospective assistance UEs. The functionality at block 630 may correspond with arrows 540 in FIG. 5. According to some embodiments, this may be in response to a request for the WLAN identification information. As such, some embodiments may further comprise, prior to receiving the WLAN identification information regarding the one or more prospective assistance UEs, sending a request from the server to the one or more prospective assistance UEs for the WLAN identification information. Any on desired functionality, the WLAN identification information may comprise a MAC address, a service set identifier (SSID), or both.

Means for performing functionality at block 630 may comprise a bus 905, one or more processors 910, communications subsystem 930, memory 935, and/or other components of a computer system 900, as illustrated in FIG. 9, described in more detail hereafter.

At block 640, the functionality comprises sending WLAN identification information of the one or more prospective assistance UEs from the server to the target UE. This functionality may correspond with arrow 545 of FIG. 5, and as such, this can enable the target UE 505 to associate and conduct positioning with the one or more prospective assistance UEs (UEs 510 and 515 in the example of FIG. 5).

Means for performing functionality at block 640 may comprise a bus 905, one or more processors 910, communications subsystem 930, memory 935, and/or other components of a computer system 900, as illustrated in FIG. 9, described in more detail hereafter.

As noted in the embodiments described herein, one or more additional features may be implemented, depending on desired functionality. For example, some embodiments may further comprise determining the one or more prospective assistance UEs based on assistance data from the target UE, location information of the target UE and the one or more prospective assistance UEs, or both. Some embodiments may further comprise receiving, at the server, WLAN positioning results from the target UE and at least a subset of the one or more prospective assistance UEs, determining, at the server, a location estimate of the target UE based on the WLAN positioning results, and sending the location estimate of the target UE from the server to the target UE.

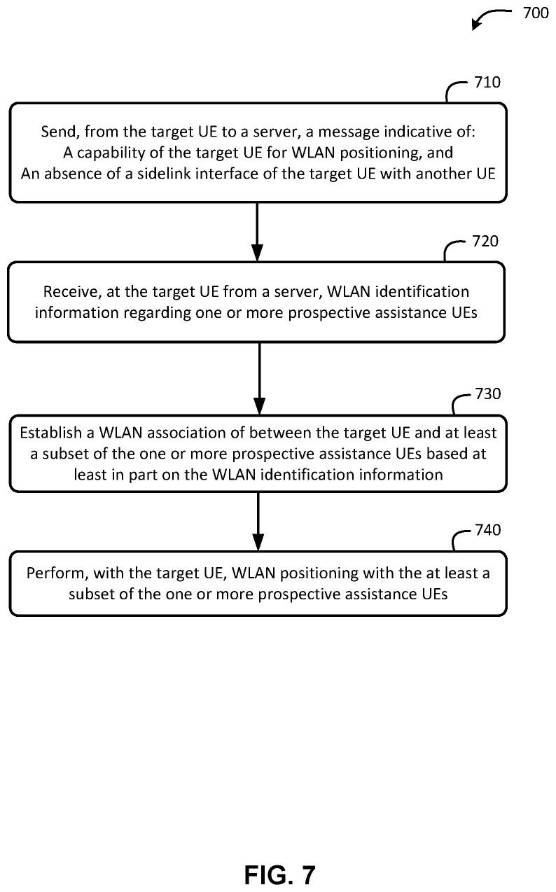

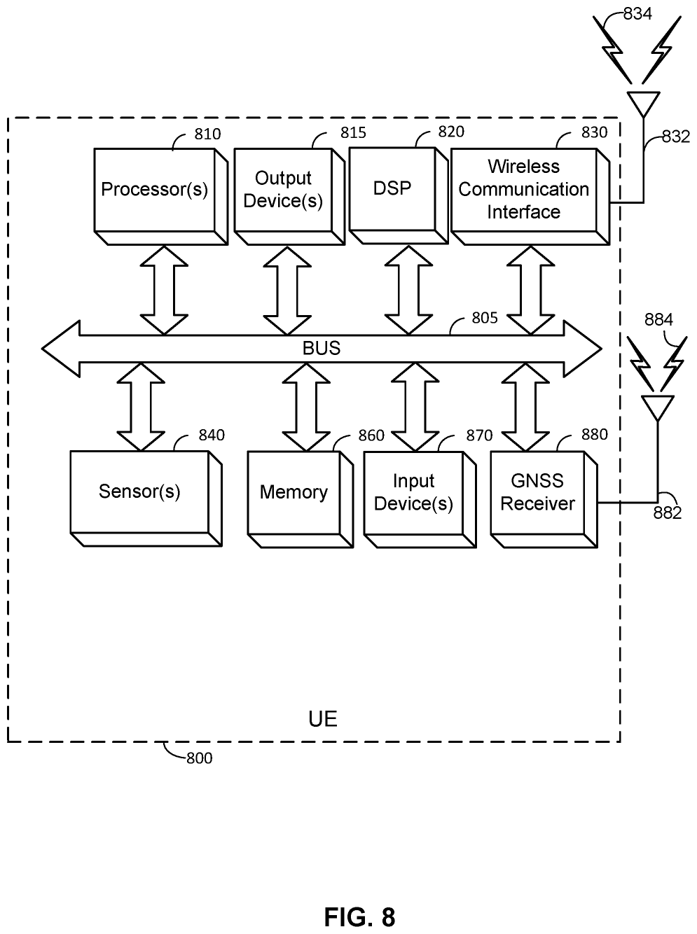

FIG. 7 is a flow diagram of a method 700 of supporting WLAN positioning of a target UE of a cellular network according to an embodiment. According to some aspects, the methods 700 and 600 of respective FIGS. 7 and 6 may be seen as methods for implementing the respective functionality at the target UE 505 and network 520 of FIG. 5. Means for performing the functionality illustrated in one or more of the blocks shown in FIG. 7 may be performed by hardware and/or software components of a UE. Example components of a UE are illustrated in FIG. 8, which is described in more detail below.

At block 710, the functionality comprises sending, from the target UE to a server, a message indicative of a capability of the target UE for WLAN positioning, and an absence of a sidelink interface of the target UE with another UE. The functionality at block 710 may echo the functionality at arrow 525 of FIG. 5, described previously. According to some embodiments, the message may comprise a positioning request, and wherein the target UE further includes, in the positioning request, assistance information comprising an indication of: an inability of the target UE to perform sidelink positioning, whether the target UE can act as a WLAN client or WLAN access point, a WLAN-AP identifier of at least one of the one or more prospective assistance UEs detected by the target UE, a MAC addresses of at least one of the one or more prospective assistance UEs detected by the target UE, a signal strength of at least one of the one or more prospective assistance UEs detected by the target UE, whether the target UE can perform in Wi-Fi Direct mode, whether the target UE can act as a peer-to-peer (P2P) group owner (GO) or a P2P client, or any combination thereof. In such embodiments, the assistance information may further comprise an indication that the target UE has a WLAN connection with at least one of the one or more prospective assistance UEs. In some embodiments, the assistance information may further comprise an indication that the WLAN connection is not authenticated and not associated, authenticated and not associated, or authenticated and associated.

Means for performing functionality at block 710 may comprise a bus 805, one or more processors 810, wireless communication interface 830, memory 870, and/or other components of a UE 800, as illustrated in FIG. 8, described in more detail hereafter.

At block 720, the functionality comprises receiving, at the target UE from a server, WLAN identification information regarding one or more prospective assistance UEs. This functionality may correspond with the functionality of arrow 545 in FIG. 5. As previously noted, according to some embodiments, WLAN identification information may comprise a MAC address, a service set identifier (SSID), or both.

Means for performing functionality at block 720 may comprise a bus 805, one or more processors 810, wireless communication interface 830, memory 870, and/or other components of a UE 800, as illustrated in FIG. 8, described in more detail hereafter.

At block 730, the functionality comprises establishing a WLAN association of between the target UE and at least a subset of the one or more prospective assistance UEs based at least in part on the WLAN identification information. This functionality may correspond with arrows 550 and 555 of FIG. 5, previously described. According to some embodiments, this association may be established in accordance with applicable WLAN standards.

Means for performing functionality at block 730 may comprise a bus 805, one or more processors 810, wireless communication interface 830, memory 870, and/or other components of a UE 800, as illustrated in FIG. 8, described in more detail hereafter.

At block 740, the functionality comprises performing, with the target UE, WLAN positioning with the at least a subset of the one or more prospective assistance UEs. This functionality may correspond with arrows 560 and 565 of FIG. 5. According to some embodiments, the target UE may further obtain positioning results from the positioning performed at block 740. In some embodiments, this result may be provided to the network for computation of a position of the target UE. For example, some embodiments may further comprise obtaining, at the target UE, a WLAN positioning result from the WLAN positioning, sending, from the target UE to the server, the WLAN positioning result to a server, and receiving, at the target UE from the server, a location estimate of the target UE. In some embodiments, the target UE itself may determine its location from a positioning result. As such, some embodiments of the method 700 may further comprise receiving, at the target UE, a WLAN positioning result from the at least a subset of the one or more prospective assistance UEs, and determining, at the target UE, a location estimate of the target UE based on the WLAN positioning result.

Means for performing functionality at block 740 may comprise a bus 805, one or more processors 810, wireless communication interface 830, memory 870, and/or other components of a UE 800, as illustrated in FIG. 8, described in more detail hereafter.

FIG. 8 is a block diagram of an embodiment of a UE 800, which can be utilized as described herein. For example, UE 800 may correspond with the target UE and/or an assistance UE (or prospective assistance UE) as described herein. It should be noted that FIG. 8 is meant only to provide a generalized illustration of various components, any or all of which may be utilized as appropriate. Furthermore, as previously noted, the functionality of the UE discussed in the previously described embodiments may be executed by one or more of the hardware and/or software components illustrated in FIG. 8.

The UE 800 is shown comprising hardware elements that can be electrically coupled via a bus 805 (or may otherwise be in communication, as appropriate). The hardware elements may include a processor(s) 810 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 810 may comprise one or more processing units, which may be housed in a single integrated circuit (IC) or multiple ICs. As shown in FIG. 8, some embodiments may have a separate DSP 820, depending on desired functionality. Location determination and/or other determinations based on wireless communication may be provided in the processor(s) 810 and/or wireless communication interface 830 (discussed below). The UE 800 also can include one or more input devices 870, which can include without limitation one or more keyboards, touch screens, touch pads, microphones, buttons, dials, switches, and/or the like; and one or more output devices 815, which can include without limitation one or more displays (e.g., touch screens), light emitting diodes (LEDs), speakers, and/or the like.

The UE 800 may also include a wireless communication interface 830, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 800 to communicate and/or perform positioning with other devices as described in the embodiments above, with respect to WLAN and/or cellular technologies. The wireless communication interface 830 may permit data and signaling to be communicated (e.g., transmitted and received) with NG-RAN nodes of a network, for example, via eNBs, gNBs, ng-eNBs, access points, NTN satellites, various base stations, TRPs, and/or other access node types, and/or other network components, computer systems, and/or any other electronic devices communicatively coupled with TRPs, as described herein. The communication can be carried out via one or more wireless communication antenna(s) 832 that send and/or receive wireless signals 834. According to some embodiments, the wireless communication antenna(s) 832 may comprise a plurality of discrete antennas, antenna arrays, or any combination thereof. The antenna(s) 832 may be capable of transmitting and receiving wireless signals using beams (e.g., Tx beams and Rx beams). Beam formation may be performed using digital and/or analog beam formation techniques, with respective digital and/or analog circuitry. The wireless communication interface 830 may include such circuitry.

Depending on desired functionality, the wireless communication interface 830 may comprise a separate receiver and transmitter, or any combination of transceivers, transmitters, and/or receivers to communicate with base stations (e.g., ng-eNBs and gNBs) and other terrestrial transceivers, such as wireless devices and access points, as well as NTN satellites. The UE 800 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 800 can further include sensor(s) 840. Sensor(s) 840 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 800 may also include a Global Navigation Satellite System (GNSS) receiver 880 capable of receiving signals 884 from one or more GNSS satellites using an antenna 882 (which could be the same as antenna 832). Positioning based on GNSS signal measurement can be utilized to complement and/or incorporate the techniques described herein. The GNSS receiver 880 can extract a position of the UE 800, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 880 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 880 is illustrated in FIG. 8 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 810, DSP 820, and/or a processor within the wireless communication interface 830 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processors, such as processor(s) 810 or DSP 820.

The UE 800 may further include and/or be in communication with a memory 860. The memory 860 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 860 of the UE 800 also can comprise software elements (not shown in FIG. 8), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 860 that are executable by the UE 800 (and/or processor(s) 810 or DSP 820 within UE 800). In some embodiments, then, such code and/or instructions can be used to configure and/or adapt a general-purpose computer (or other device) to perform one or more operations in accordance with the described methods.

FIG. 9 is a block diagram of an embodiment of a computer system 900, which may be used, in whole or in part, to provide the functions of one or more components and/or devices as described in the embodiments herein. The computer system 900, for example, may be utilized within and/or executed by a server (e.g., location server/LMF) as described herein. It should be noted that FIG. 9 is meant only to provide a generalized illustration of various components, any or all of which may be utilized as appropriate. FIG. 9, therefore, broadly illustrates how individual system elements may be implemented in a relatively separated or relatively more integrated manner. In addition, it can be noted that components illustrated by FIG. 9 can be localized to a single device and/or distributed among various networked devices, which may be disposed at different geographical locations.

The computer system 900 is shown comprising hardware elements that can be electrically coupled via a bus 905 (or may otherwise be in communication, as appropriate). The hardware elements may include processor(s) 910, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 900 also may comprise one or more input devices 915, which may comprise without limitation a mouse, a keyboard, a camera, a microphone, and/or the like; and one or more output devices 920, which may comprise without limitation a display device, a printer, and/or the like.

The computer system 900 may further include (and/or be in communication with) one or more non-transitory storage devices 925, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 900 may also include a communications subsystem 930, which may comprise wireless communication technologies managed and controlled by a wireless communication interface 933, as well as wired technologies (such as Ethernet, coaxial communications, universal serial bus (USB), and the like). The wireless communication interface 933 may comprise one or more wireless transceivers that may send and receive wireless signals 955 (e.g., signals according to 5G NR or LTE) via wireless antenna(s) 950. Thus the communications subsystem 930 may comprise a modem, a network card (wireless or wired), an infrared communication device, a wireless communication device, and/or a chipset, and/or the like, which may enable the computer system 900 to communicate on any or all of the communication networks described herein to any device on the respective network, including UE, base stations and/or other transmission reception points (TRPs), satellites, and/or any other electronic devices described herein. Hence, the communications subsystem 930 may be used to receive and send data as described in the embodiments herein.

In many embodiments, the computer system 900 will further comprise a working memory 935, which may comprise a RAM or ROM device, as described above. Software elements, shown as being located within the working memory 935, may comprise an operating system 940, device drivers, executable libraries, and/or other code, such as one or more applications 945, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 925 described above. In some cases, the storage medium might be incorporated within a computer system, such as computer system 900. In other embodiments, the storage medium might be separate from a computer system (e.g., a removable medium, such as an optical disc), and/or provided in an installation package, such that the storage medium can be used to program, configure, and/or adapt a general-purpose computer with the instructions/code stored thereon. These instructions might take the form of executable code, which is executable by the computer system 900 and/or might take the form of source and/or installable code, which, upon compilation and/or installation on the computer system 900 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses.

Clause 1: A method of supporting wireless local area network (WLAN) positioning of a target user equipment (UE) by a server of a cellular network, the method comprising: receiving, at the server from the target UE, a message indicative of: a capability of the target UE for WLAN positioning, and an absence of a sidelink interface of the target UE with another UE; sending instructions from the server to one or more prospective assistance UEs to initiate WLAN functionality to enable the target UE to associate with the one or more prospective assistance UEs; receiving, at the server from the one or more prospective assistance UEs, WLAN identification information of the one or more prospective assistance UEs; and sending the WLAN identification information of the one or more prospective assistance UEs from the server to the target UE.

Clause 2: The method of clause 1, wherein the server comprises a Location Management Function (LMF) and the message is received via LTE Positioning Protocol (LPP) or Non-Access Stratum (NAS) signaling.

Clause 3: The method of any one of clauses 1-2 wherein the message comprises a positioning request, and wherein the positioning request further includes assistance information comprising an indication of: an inability of the target UE to perform sidelink positioning, whether the target UE can act as a WLAN client or WLAN access point, a WLAN-AP identifier of at least one of the one or more prospective assistance UEs detected by the target UE, a MAC addresses of at least one of the one or more prospective assistance UEs detected by the target UE, a signal strength of at least one of the one or more prospective assistance UEs detected by the target UE, whether the target UE can perform in Wi-Fi Direct mode, whether the target UE can act as a peer-to-peer (P2P) group owner (GO) or a P2P client, or any combination thereof.

Clause 4: The method of clause 3 wherein the assistance information further comprises an indication that the target UE has a WLAN connection with at least one of the one or more prospective assistance UEs.

Clause 5: The method of clause 4 wherein the assistance information further comprises an indication that the WLAN connection is: not authenticated and not associated, authenticated and not associated, or authenticated and associated.

Clause 6: The method of any one of clauses 1-5 further comprising determining the one or more prospective assistance UEs based on assistance data from the target UE, location information of the target UE and the one or more prospective assistance UEs, or both.

Clause 7: The method of any one of clauses 1-6 further comprising receiving, at the server, WLAN positioning results from the target UE and at least a subset of the one or more prospective assistance UEs; determining, at the server, a location estimate of the target UE based on the WLAN positioning results; and sending the location estimate of the target UE from the server to the target UE.

Clause 8: The method of any one of clauses 1-7 wherein the instructions to initiate WLAN functionality comprise instructions to: operate as a WLAN access point (AP), enable Wi-Fi direct mode, act as a peer-to-peer (P2P) group owner (GO) or a P2P client, or any combination thereof.

Clause 9: The method of any one of clauses 1-8 further comprising, prior to receiving the WLAN identification information regarding the one or more prospective assistance UEs, sending a request from the server to the one or more prospective assistance UEs for the WLAN identification information.

Clause 10: The method of clause 9 wherein the WLAN identification information comprises: a MAC address, a service set identifier (SSID), or both.

Clause 11: A method of supporting wireless local area network (WLAN) positioning of a target user equipment (UE) of a cellular network, the method comprising: sending, from the target UE to a server, a message indicative of: a capability of the target UE for WLAN positioning, and an absence of a sidelink interface of the target UE with another UE; receiving, at the target UE from a server, WLAN identification information regarding one or more prospective assistance UEs; establishing a WLAN association of between the target UE and at least a subset of the one or more prospective assistance UEs based at least in part on the WLAN identification information; and performing, with the target UE, WLAN positioning with the at least a subset of the one or more prospective assistance UEs.

Clause 12: The method of clause 11, further comprising: obtaining, at the target UE, a WLAN positioning result from the WLAN positioning; sending, from the target UE to the server, the WLAN positioning result to a server; and receiving, at the target UE from the server, a location estimate of the target UE.

Clause 13: The method of any one of clauses 11-12 further comprising receiving, at the target UE, a WLAN positioning result from the at least a subset of the one or more prospective assistance UEs; and determining, at the target UE, a location estimate of the target UE based on the WLAN positioning result.

Clause 14: The method of any one of clauses 11-13 wherein the message comprises a positioning request, and wherein the target UE further includes, in the positioning request, assistance information comprising an indication of: an inability of the target UE to perform sidelink positioning, whether the target UE can act as a WLAN client or WLAN access point, a WLAN-AP identifier of at least one of the one or more prospective assistance UEs detected by the target UE, a MAC addresses of at least one of the one or more prospective assistance UEs detected by the target UE, a signal strength of at least one of the one or more prospective assistance UEs detected by the target UE, whether the target UE can perform in Wi-Fi Direct mode, whether the target UE can act as a peer-to-peer (P2P) group owner (GO) or a P2P client, or any combination thereof.

Clause 15: The method of clause 14 wherein the assistance information further comprises an indication that the target UE has a WLAN connection with at least one of the one or more prospective assistance UEs.

Clause 16: The method of clause 15 wherein the assistance information further comprises an indication that the WLAN connection is: not authenticated and not associated, authenticated and not associated, or authenticated and associated.

Clause 17: A server for supporting wireless local area network (WLAN) positioning of a target user equipment (UE) by a server of a cellular network, the server comprising: a transceiver; one or more memories; and one or more processors communicatively coupled with the transceiver and the one or more memories, wherein the one or more processors are configured to: receive, via the transceiver from the target UE, a message indicative of: a capability of the target UE for WLAN positioning, and an absence of a sidelink interface of the target UE with another UE; send instructions via the transceiver to one or more prospective assistance UEs to initiate WLAN functionality to enable the target UE to associate with the one or more prospective assistance UEs; receive, via the transceiver from the one or more prospective assistance UEs, WLAN identification information of the one or more prospective assistance UEs; and send the WLAN identification information of the one or more prospective assistance UEs via the transceiver to the target UE.

Clause 18: The server of clause 17, wherein the server comprises a Location Management Function (LMF) and wherein the one or more processors are configured to receive the message via LTE Positioning Protocol (LPP) or Non-Access Stratum (NAS) signaling.

Clause 19: The server of any one of clauses 17-18 wherein, to receive the message, the one or more processors are configured to receive a positioning request including assistance information comprising an indication of an inability of the target UE to perform sidelink positioning, whether the target UE can act as a WLAN client or WLAN access point, a WLAN-AP identifier of at least one of the one or more prospective assistance UEs detected by the target UE, a MAC addresses of at least one of the one or more prospective assistance UEs detected by the target UE, a signal strength of at least one of the one or more prospective assistance UEs detected by the target UE, whether the target UE can perform in Wi-Fi Direct mode, whether the target UE can act as a peer-to-peer (P2P) group owner (GO) or a P2P client, or any combination thereof.

Clause 20: The server of clause 19 wherein, to receive the assistance information, the one or more processors are configured to receive an indication that the target UE has a WLAN connection with at least one of the one or more prospective assistance UEs.

Clause 21: The server of clause 20 wherein, to receive the assistance information, the one or more processors are configured to receive an indication that the WLAN connection is not authenticated and not associated, authenticated and not associated, or authenticated and associated.

Clause 22: The server of any one of clauses 17-21 wherein the one or more processors are further configured to determine the one or more prospective assistance UEs based on assistance data from the target UE, location information of the target UE and the one or more prospective assistance UEs, or both.

Clause 23: The server of any one of clauses 17-22 wherein the one or more processors are further configured to: receive, via the transceiver, WLAN positioning results from the target UE and at least a subset of the one or more prospective assistance UEs; determine a location estimate of the target UE based on the WLAN positioning results; and send the location estimate of the target UE via the transceiver to the target UE.

Clause 24: The server of any one of clauses 17-23 wherein the one or more processors are configured to include, in the instructions to initiate WLAN functionality, instructions to: operate as a WLAN access point (AP), enable Wi-Fi direct mode, act as a peer-to-peer (P2P) group owner (GO) or a P2P client, or any combination thereof.

Clause 25: The server of any one of clauses 17-24 wherein the one or more processors are further configured to, prior to receiving the WLAN identification information regarding the one or more prospective assistance UEs, send a request from the server to the one or more prospective assistance UEs for the WLAN identification information.

Clause 26: A target UE for supporting wireless local area network (WLAN) positioning of a target user equipment (UE) of a cellular network, the target UE comprising: a transceiver; one or more memories; and one or more processors communicatively coupled with the transceiver and the one or more memories, wherein the one or more processors are configured to: send, via the transceiver to a server, a message indicative of: a capability of the target UE for WLAN positioning, and an absence of a sidelink interface of the target UE with another UE; receive, via the transceiver from a server, WLAN identification information regarding one or more prospective assistance UEs; establish a WLAN association of between the target UE and at least a subset of the one or more prospective assistance UEs based at least in part on the WLAN identification information; and perform WLAN positioning with the at least a subset of the one or more prospective assistance UEs.

Clause 27: The target UE of clause 26, wherein the one or more processors are further configured to: obtain, at the target UE, a WLAN positioning result from the WLAN positioning; send, from the target UE to the server, the WLAN positioning result to a server; and receive, at the target UE from the server, a location estimate of the target UE.

Clause 28: The target UE of any one of clauses 26-27 wherein the one or more processors are further configured to: receive, via the transceiver, a WLAN positioning result from the at least a subset of the one or more prospective assistance UEs; and determine a location estimate of the target UE based on the WLAN positioning result.

Clause 29: The target UE of any one of clauses 26-28 wherein the one or more processors are configured to include, in the message, a positioning request with assistance information comprising an indication of: an inability of the target UE to perform sidelink positioning, whether the target UE can act as a WLAN client or WLAN access point, a WLAN-AP identifier of at least one of the one or more prospective assistance UEs detected by the target UE, a MAC addresses of at least one of the one or more prospective assistance UEs detected by the target UE, a signal strength of at least one of the one or more prospective assistance UEs detected by the target UE, whether the target UE can perform in Wi-Fi Direct mode, whether the target UE can act as a peer-to-peer (P2P) group owner (GO) or a P2P client, or any combination thereof.

Clause 30: The target UE of clause 29 wherein the one or more processors are configured to include, in the assistance information, an indication that the target UE has a WLAN connection with at least one of the one or more prospective assistance UEs.

What is claimed is:

1. A method of supporting wireless local area network (WLAN) positioning of a target user equipment (UE) by a server of a cellular network, the method comprising:
receiving, at the server from the target UE, a message indicative of:
a capability of the target UE for WLAN positioning, and
an absence of a sidelink interface of the target UE with another UE;
sending instructions from the server to one or more prospective assistance UEs to initiate WLAN functionality to enable the target UE to associate with the one or more prospective assistance UEs;
receiving, at the server from the one or more prospective assistance UEs, WLAN identification information of the one or more prospective assistance UEs; and
sending the WLAN identification information of the one or more prospective assistance UEs from the server to the target UE.

2. The method of claim 1, wherein the server comprises a Location Management Function (LMF) and the message is received via LTE Positioning Protocol (LPP) or Non-Access Stratum (NAS) signaling.

3. The method of claim 1, wherein the message comprises a positioning request, and wherein the positioning request further includes assistance information comprising an indication of:
an inability of the target UE to perform sidelink positioning,
whether the target UE can act as a WLAN client or WLAN access point,
a WLAN-AP identifier of at least one of the one or more prospective assistance UEs detected by the target UE,
a MAC addresses of at least one of the one or more prospective assistance UEs detected by the target UE,
a signal strength of at least one of the one or more prospective assistance UEs detected by the target UE,
whether the target UE can perform in Wi-Fi Direct mode,
whether the target UE can act as a peer-to-peer (P2P) group owner (GO) or a P2P client, or
any combination thereof.

4. The method of claim 3, wherein the assistance information further comprises an indication that the target UE has a WLAN connection with at least one of the one or more prospective assistance UEs.

5. The method of claim 4, wherein the assistance information further comprises an indication that the WLAN connection is:
not authenticated and not associated,
authenticated and not associated, or
authenticated and associated.

6. The method of claim 1, further comprising determining the one or more prospective assistance UEs based on assistance data from the target UE, location information of the target UE and the one or more prospective assistance UEs, or both.

7. The method of claim 1, further comprising:
receiving, at the server, WLAN positioning results from the target UE and at least a subset of the one or more prospective assistance UEs;
determining, at the server, a location estimate of the target UE based on the WLAN positioning results; and
sending the location estimate of the target UE from the server to the target UE.

8. The method of claim 1, wherein the instructions to initiate WLAN functionality comprise instructions to:
operate as a WLAN access point (AP),
enable Wi-Fi direct mode,
act as a peer-to-peer (P2P) group owner (GO) or a P2P client, or
any combination thereof.

9. The method of claim 1, further comprising, prior to receiving the WLAN identification information of the one or more prospective assistance UEs, sending a request from the server to the one or more prospective assistance UEs for the WLAN identification information.

10. The method of claim 9, wherein the WLAN identification information comprises:
a MAC address,
a service set identifier (SSID), or
both.

11. A method of supporting wireless local area network (WLAN) positioning of a target user equipment (UE) of a cellular network, the method comprising:
sending, from the target UE to a server, a message indicative of:
a capability of the target UE for WLAN positioning, and
an absence of a sidelink interface of the target UE with another UE;
receiving, at the target UE from a server, WLAN identification information regarding one or more prospective assistance UEs;
establishing a WLAN association of between the target UE and at least a subset of the one or more prospective assistance UEs based at least in part on the WLAN identification information; and
performing, with the target UE, WLAN positioning with the at least a subset of the one or more prospective assistance UEs.

12. The method of claim 11, further comprising:
obtaining, at the target UE, a WLAN positioning result from the WLAN positioning;
sending, from the target UE to the server, the WLAN positioning result to a server; and
receiving, at the target UE from the server, a location estimate of the target UE.

13. The method of claim 11, further comprising:
receiving, at the target UE, a WLAN positioning result from the at least a subset of the one or more prospective assistance UEs; and
determining, at the target UE, a location estimate of the target UE based on the WLAN positioning result.

14. The method of claim 11, wherein the message comprises a positioning request, and wherein the target UE further includes, in the positioning request, assistance information comprising an indication of:
an inability of the target UE to perform sidelink positioning,
whether the target UE can act as a WLAN client or WLAN access point,
a WLAN-AP identifier of at least one of the one or more prospective assistance UEs detected by the target UE,
a MAC addresses of at least one of the one or more prospective assistance UEs detected by the target UE,
a signal strength of at least one of the one or more prospective assistance UEs detected by the target UE,
whether the target UE can perform in Wi-Fi Direct mode,
whether the target UE can act as a peer-to-peer (P2P) group owner (GO) or a P2P client, or
any combination thereof.

15. The method of claim 14, wherein the assistance information further comprises an indication that the target UE has a WLAN connection with at least one of the one or more prospective assistance UEs.

16. The method of claim 15, wherein the assistance information further comprises an indication that the WLAN connection is:
not authenticated and not associated,
authenticated and not associated, or
authenticated and associated.

17. A server for supporting wireless local area network (WLAN) positioning of a target user equipment (UE) by a server of a cellular network, the server comprising:
a transceiver;
one or more memories; and
one or more processors communicatively coupled with the transceiver and the one or more memories, wherein the one or more processors are configured to:
receive, via the transceiver from the target UE, a message indicative of:
a capability of the target UE for WLAN positioning, and
an absence of a sidelink interface of the target UE with another UE;
send instructions via the transceiver to one or more prospective assistance UEs to initiate WLAN functionality to enable the target UE to associate with the one or more prospective assistance UEs;
receive, via the transceiver from the one or more prospective assistance UEs, WLAN identification information of the one or more prospective assistance UEs; and
send the WLAN identification information of the one or more prospective assistance UEs via the transceiver to the target UE.

18. The server of claim 17, wherein the server comprises a Location Management Function (LMF) and wherein the one or more processors are configured to receive the message via LTE Positioning Protocol (LPP) or Non-Access Stratum (NAS) signaling.

19. The server of claim 17, wherein, to receive the message, the one or more processors are configured to receive a positioning request including assistance information comprising an indication of:
an inability of the target UE to perform sidelink positioning,
whether the target UE can act as a WLAN client or WLAN access point,
a WLAN-AP identifier of at least one of the one or more prospective assistance UEs detected by the target UE,
a MAC addresses of at least one of the one or more prospective assistance UEs detected by the target UE,
a signal strength of at least one of the one or more prospective assistance UEs detected by the target UE,
whether the target UE can perform in Wi-Fi Direct mode,
whether the target UE can act as a peer-to-peer (P2P) group owner (GO) or a P2P client, or
any combination thereof.

20. The server of claim 19, wherein, to receive the assistance information, the one or more processors are configured to receive an indication that the target UE has a WLAN connection with at least one of the one or more prospective assistance UEs.

21. The server of claim 20, wherein, to receive the assistance information, the one or more processors are configured to receive an indication that the WLAN connection is:
not authenticated and not associated,
authenticated and not associated, or
authenticated and associated.

22. The server of claim 17, wherein the one or more processors are further configured to determine the one or more prospective assistance UEs based on assistance data from the target UE, location information of the target UE and the one or more prospective assistance UEs, or both.

23. The server of claim 17, wherein the one or more processors are further configured to:
receive, via the transceiver, WLAN positioning results from the target UE and at least a subset of the one or more prospective assistance UEs;
determine a location estimate of the target UE based on the WLAN positioning results; and
send the location estimate of the target UE via the transceiver to the target UE.

24. The server of claim 17, wherein the one or more processors are configured to include, in the instructions to initiate WLAN functionality, instructions to:
operate as a WLAN access point (AP),
enable Wi-Fi direct mode,
act as a peer-to-peer (P2P) group owner (GO) or a P2P client, or
any combination thereof.

25. The server of claim 17, wherein the one or more processors are further configured to, prior to receiving the WLAN identification information of the one or more prospective assistance UEs, send a request from the server to the one or more prospective assistance UEs for the WLAN identification information.

26. A target UE for supporting wireless local area network (WLAN) positioning of a target user equipment (UE) of a cellular network, the target UE comprising:
a transceiver;
one or more memories; and
one or more processors communicatively coupled with the transceiver and the one or more memories, wherein the one or more processors are configured to:
send, via the transceiver to a server, a message indicative of:
a capability of the target UE for WLAN positioning, and
an absence of a sidelink interface of the target UE with another UE;
receive, via the transceiver from a server, WLAN identification information regarding one or more prospective assistance UEs;
establish a WLAN association of between the target UE and at least a subset of the one or more prospective assistance UEs based at least in part on the WLAN identification information; and
perform WLAN positioning with the at least a subset of the one or more prospective assistance UEs.

27. The target UE of claim 26, wherein the one or more processors are further configured to:
obtain, at the target UE, a WLAN positioning result from the WLAN positioning;
send, from the target UE to the server, the WLAN positioning result to a server; and
receive, at the target UE from the server, a location estimate of the target UE.

28. The target UE of claim 26, wherein the one or more processors are further configured to:
receive, via the transceiver, a WLAN positioning result from the at least a subset of the one or more prospective assistance UEs; and
determine a location estimate of the target UE based on the WLAN positioning result.

29. The target UE of claim 26, wherein the one or more processors are configured to include, in the message, a positioning request with assistance information comprising an indication of:
an inability of the target UE to perform sidelink positioning,
whether the target UE can act as a WLAN client or WLAN access point,
a WLAN-AP identifier of at least one of the one or more prospective assistance UEs detected by the target UE,
a MAC addresses of at least one of the one or more prospective assistance UEs detected by the target UE,
a signal strength of at least one of the one or more prospective assistance UEs detected by the target UE,
whether the target UE can perform in Wi-Fi Direct mode,
whether the target UE can act as a peer-to-peer (P2P) group owner (GO) or a P2P client, or
any combination thereof.

30. The target UE of claim 29, wherein the one or more processors are configured to include, in the assistance information, an indication that the target UE has a WLAN connection with at least one of the one or more prospective assistance UEs.
